(19) United States
(12) Patent Application Publication
(10) Pub. No.: US 2025/0297388 A1
(43) Pub. Date: Sep. 25, 2025

(54) CHANNEL STRUCTURE AND ELECTROCHEMICAL CELL

(71) Applicant: NGK INSULATORS, LTD., Nagoya-shi (JP)

(72) Inventors: Takashi SHIRATORI, Nagoya-shi (JP); Toshiyuki NAKAMURA, Handa-shi (JP); Genta TERAZAWA, Nagoya-shi (JP); Makoto OHMORI, Nagoya-shi (JP)

(21) Appl. No.: 18/829,461

(22) Filed: Sep. 10, 2024

Related U.S. Application Data
(63) Continuation of application No. PCT/JP2024/010777, filed on Mar. 19, 2024.

(51) Int. Cl. C25B 13/02; C25B 11/032; C25B 13/05; C25B 13/07

(52) U.S. Cl. CPC C25B 13/02; C25B 11/032; C25B 13/05; C25B 13/07

(57) ABSTRACT

The present channel structure includes a first substrate, a second substrate, and a spacer. The first substrate includes a gas permeated portion. The gas permeated portion is a portion causing a gas to permeate therethrough. The second substrate includes a protrusion. The protrusion protrudes toward the first substrate. The spacer is disposed between the protrusion and the first substrate. The spacer is configured to produce a gap between the protrusion and the first substrate.

### CROSS-REFERENCE TO RELATED APPLICATIONS

This is a continuation of PCT/JP2024/010777, filed Mar. 19, 2024, the entire contents of which are hereby incorporated by reference.

### TECHNICAL FIELD

The present invention relates to a channel structure and an electrochemical cell.

### BACKGROUND ART

Supporting a cell body by a metallic substrate has been known as a structure for an electrochemical cell such as an electrolytic cell, a fuel cell, or so forth. For example, an electrochemical cell disclosed in WO2018/181926 A1 is structured such that an electrode layer, an electrolyte layer, and a counter electrode layer are laminated on a metallic substrate in this order. The metallic substrate includes a plurality of through holes for supplying raw material gas to the electrode layer.

Besides, the electrochemical cell includes an inter-connector serving as a channel for the raw material gas. The inter-connector includes a plurality of protrusions protruding toward the metallic substrate. Each protrusion is configured to be in contact with the metallic substrate.

### SUMMARY OF THE INVENTION

### Technical Problems

In the electrochemical cell including the inter-connector as described above, one or more of the plural through holes in the metallic substrate are undesirably covered with one or more of the plural protrusions on the inter-connector; hence, degradation in performance of the electrochemical cell can be problematic.

In view of the above, it is an object of the present invention to inhibit degradation in performance of an electrochemical cell.

### Solution to Problems

A channel structure according to a first aspect includes a first substrate, a second substrate, and a spacer. The first substrate includes a gas permeated portion. The gas permeated portion causes a gas to permeate therethrough. The second substrate includes a protrusion. The protrusion protrudes toward the first substrate. The spacer is disposed between the protrusion and the first substrate. The spacer is configured to produce a gap between the protrusion and the first substrate.

According to this configuration, the gap is produced between the protrusion and the first substrate by the spacer; hence, a through hole can be prevented from being covered with the protrusion. As a result, degradation in performance of an electrochemical cell can be inhibited.

A channel structure according to a second aspect relates to the channel structure according to the first aspect and is configured as follows. The first substrate includes a through hole as the gas permeated portion.

A channel structure according to a third aspect relates to the channel structure according to the second aspect and is configured as follows. The spacer is disposed along the through hole.

A channel structure according to a fourth aspect relates to the channel structure according to the third aspect and is configured as follows. The spacer extends in an annular shape and is uneven in height.

A channel structure according to a fifth aspect relates to the channel structure according to the third or fourth aspect and is configured as follows. The spacer intermittently extends in an annular shape.

A channel structure according to a sixth aspect relates to the channel structure according to any of the first to fifth aspects and is configured as follows. The spacer is fixed to the first substrate.

A channel structure according to a seventh aspect relates to the channel structure according to any of the first to sixth aspects and is configured as follows. The spacer is fixed to the protrusion.

A channel structure according to an eighth aspect relates to the channel structure according to any of the first to seventh aspects and is configured as follows. The spacer is made of a material containing oxide.

A channel structure according to a ninth aspect relates to the channel structure according to any of the first to eighth aspects and is configured as follows. The spacer is made of a material containing metal.

An electrochemical cell according to a tenth aspect includes the channel structure recited in any of the first to ninth aspects and a cell body. The cell body is disposed on the first substrate. The cell body includes an anode, an electrolyte, and a cathode.

### Advantageous Effects of Invention

According to the present invention, degradation in performance of an electrochemical cell can be inhibited.

### BRIEF DESCRIPTION OF THE DRAWINGS

FIG. 1 is a plan view of an electrolytic cell.

FIG. 2 is a cross-sectional view of the electrolytic cell taken along line II-II in FIG. 1.

FIG. 3 is a plan view of an inter-connector.

FIG. 4 is an enlarged cross-sectional view of the electrolytic cell.

FIG. 5 is a plan view of a spacer.

FIG. 6 is a plan view of a spacer according to a modification.

FIG. 7 is a plan view of a spacer according to another modification.

FIG. 8 is a plan view of an inter-connector according to a modification.

### DESCRIPTION OF EMBODIMENTS

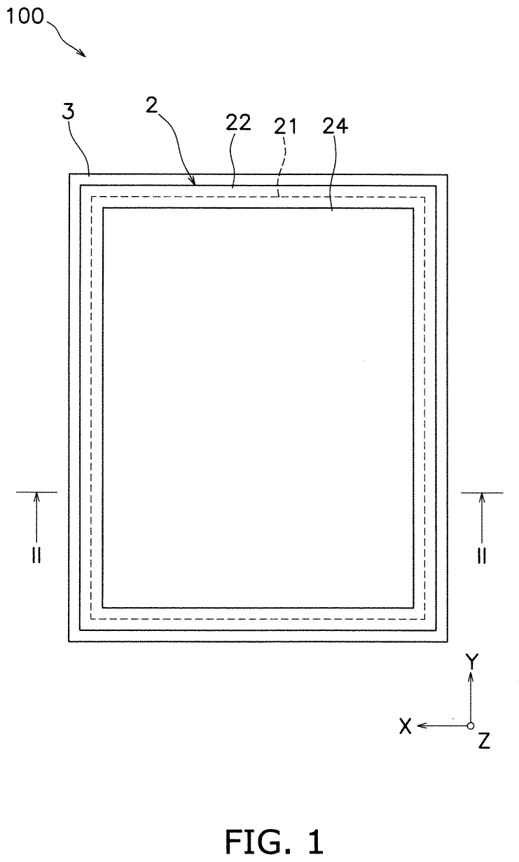

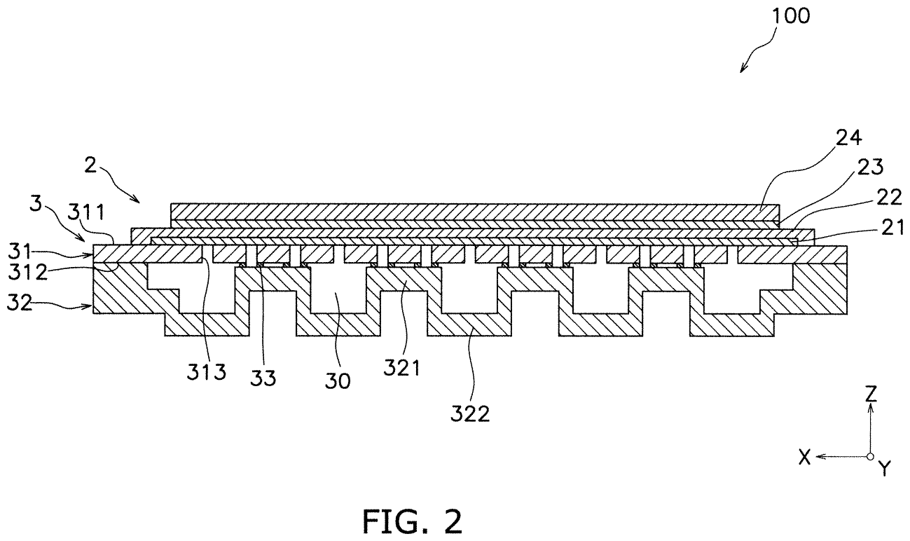

An electrolytic cell 100 (exemplary electrochemical cell) according to the present preferred embodiment will be hereinafter explained with reference to drawings. It should be noted that in the present preferred embodiment, explanation will be made with a solid oxide electrolytic cell (SOEC) as an example of the electrolytic cell 100. FIG. 1 is a plan view of the electrolytic cell 100. FIG. 2 is a cross-sectional view of the electrolytic cell 100 taken along line II-II in FIG. 1.

### Electrolytic Cell

As shown in FIGS. 1 and 2, the electrolytic cell 100 (exemplary electrochemical cell) is made in shape of a plate extending in an X-axis direction and a Y-axis direction. In the present preferred embodiment, when seen in a plan view along a Z-axis direction perpendicular to both the X-axis and Y-axis directions, the electrolytic cell 100 is made in shape of a rectangle elongated in the Y-axis direction. However, the electrolytic cell 100 is not particularly limited in planar shape; hence, the planar shape thereof may be a polygon, an ellipse, a circle, or so forth other than the rectangle. It should be noted that the Z-axis direction means the thickness direction of the electrolytic cell 100, a cell body 2, and a channel structure 3.

As shown in FIGS. 1 and 2, the electrolytic cell 100 includes the cell body 2 and the channel structure 3.

### Cell Body

The cell body 2 is disposed on the channel structure 3. The cell body 2 is supported by a support substrate 31 (to be described) composing part of the channel structure 3. The cell body 2 is disposed on the support substrate 31 to cover a plurality of through holes 313 (to be described). The cell body 2 includes a hydrogen electrode 21 (cathode), an electrolyte 22, a reaction preventing layer 23, and an oxygen electrode 24 (anode).

The hydrogen electrode 21, the electrolyte 22, the reaction preventing layer 23, and the oxygen electrode 24 are laminated in this order from the channel structure 3 side along the Z-axis direction. The hydrogen electrode 21, the electrolyte 22, and the oxygen electrode 24 are essential components; however, the reaction preventing layer 23 is a component provided on an arbitrary basis.

### Hydrogen Electrode

The hydrogen electrode 21 is disposed on a first principal surface 311 of the support substrate 31. The hydrogen electrode 21 is supplied with raw material gas via each of the through holes 313 of the support substrate 31. The raw material gas contains at least water vapor (H₂O). The hydrogen electrode 21 generates H₂ with electrolytic reactions.

When the raw material gas contains only H₂O, the hydrogen electrode 21 generates H₂ from the raw material gas by electrochemical reactions of water electrolysis expressed in the following formula (1).

Hydrogen electrode 21: H₂O+2e⁻→H₂+O²⁻ . . . (1)

When the raw material gas contains CO₂ in addition to H₂O, the hydrogen electrode 21 generates H₂, CO, and O²⁻ from the raw material gas by electrochemical reactions of co-electrolysis expressed in the following formulae (2), (3), and (4).

Hydrogen electrode 21: CO₂+H₂O+4e⁻→CO+H₂+2O²⁻ . . . (2)

Electrochemical reaction of H₂O: H₂O+2e⁻→H₂+O²⁻ . . . (3)

Electrochemical reaction of CO₂: CO₂+2e⁻→CO+O²⁻ . . . (4)

H₂ generated in the hydrogen electrode 21 flows out via each of the through holes 313 of the support substrate 31 to an internal space 30 (to be described).

The hydrogen electrode 21 is a porous body with electronic conductivity. The hydrogen electrode 21 contains nickel (Ni). In co-electrolysis, Ni not only functions as an electron transmitter but also functions as a thermal catalyst that maintains a gas composition appropriate for methanation, FT (Fischer-Tropsch) synthesis, and so forth by promoting thermal reactions between H₂ to be generated and CO₂ contained in the raw material gas. During operating the electrolytic cell 100, Ni contained in the hydrogen electrode 21 basically exists in a state of metal (Ni) but may exist in part in a state of nickel oxide (NiO).

The hydrogen electrode 21 may contain an ionic conductive material. For example, the following can be used as the ionic conductive material: one selected from the group of yttria-stabilized zirconia (YSZ), calcia-stabilized zirconia (CSZ), scandia-stabilized zirconia (ScSZ), gadolinium-doped ceria (GDC), samarium-doped ceria (SDC), (La, Sr)(Cr, Mn)O₃, (La, Sr)TiO₃, Sr₂(Fe, Mo)₂O₆, (La, Sr)VO₃, and (La, Sr)FeO₃, a mixed material obtained by a combination of two or more of the group, or so forth.

The hydrogen electrode 21 is not particularly limited in thickness, and hence, can be set to have a thickness of, for instance, greater than or equal to 1 μm and less than or equal to 100 μm. The hydrogen electrode 21 is not particularly limited in thermal expansion coefficient, and hence, can be set to have a thermal expansion coefficient of, for instance, greater than or equal to 12×10⁻⁶/° C. and less than or equal to 20×10⁻⁶/° C.

The hydrogen electrode 21 is not particularly limited in method of formation, and hence, can be formed by any of the methods such as firing, spray coating (thermal spraying, aerosol deposition, aerosol gas deposition, powder jet deposition, particle jet deposition, cold spraying, etc.), PVD (spattering, pulse laser deposition, etc.), and CVD.

### Electrolyte

The electrolyte 22 is formed on the hydrogen electrode 21. The electrolyte 22 is disposed between the hydrogen electrode 21 and the oxygen electrode 24. In the present preferred embodiment, the electrolyte 22 is connected to both the hydrogen electrode 21 and the reaction preventing layer 23, while being interposed therebetween.

The electrolyte 22 not only covers the hydrogen electrode 21 but also covers a region, exposed without being covered with the hydrogen electrode 21, on the first principal surface 311 of the support substrate 31.

The electrolyte 22 is a dense body with oxide ionic conductivity. The electrolyte 22 transmits O²⁻, generated in the hydrogen electrode 21, to the oxygen electrode 24 side. The electrolyte 22 is made of an oxide ionic conductive material. The electrolyte 22 can be made of, for instance, YSZ, GDC, ScSZ, SDC, LSGM (lanthanum gallate), or so forth but is preferably made of YSZ.

The electrolyte 22 is not particularly limited in thickness, and hence, can be set to have a thickness of, for instance, greater than or equal to 1 μm and less than or equal to 100 μm. The electrolyte 22 is not particularly limited in thermal expansion coefficient, and hence, can be set to have a thermal expansion coefficient of, for instance, greater than or equal to 10×10⁻⁶/° C. and less than or equal to 12×10⁻⁶/°° C.

The electrolyte 22 is not particularly limited in method of formation, and hence, can be formed by any of the methods such as firing, spray coating, PVD, and CVD.

### Reaction Preventing Layer

The reaction preventing layer 23 is disposed between the electrolyte 22 and the oxygen electrode 24. The reaction preventing layer 23 is disposed on the opposite side of the electrolyte 22 from the side on which the hydrogen electrode 21 is disposed, with reference to the electrolyte 22. The reaction preventing layer 23 inhibits a layer with high electric resistance from being formed by reactions between the element of which the electrolyte 22 is made and the element of which the oxygen electrode 24 is made.

The reaction preventing layer 23 is made of an oxide ionic conductive material. The reaction preventing layer 23 can be made of GDC, SDC, or so forth.

The reaction preventing layer 23 is not particularly limited in porosity, and hence, can be set to have a porosity of, for instance, greater than or equal to 0.1% and less than or equal to 50%. The reaction preventing layer 23 is not particularly limited in thickness, and hence, can be set to have a thickness of, for instance, greater than or equal to 1 μm and less than or equal to 50 μm.

The reaction preventing layer 23 is not particularly limited in method of formation, and hence, can be formed by any of the methods such as firing, spray coating, PVD, and CVD.

### Oxygen Electrode

The oxygen electrode 24 is disposed on the opposite side of the electrolyte 22 from the side on which the hydrogen electrode 21 is disposed, with reference to the electrolyte 22. In the present preferred embodiment, the reaction preventing layer 23 is disposed between the electrolyte 22 and the oxygen electrode 24; hence, the oxygen electrode 24 is connected to the reaction preventing layer 23. When the reaction preventing layer 23 is not disposed between the electrolyte 22 and the oxygen electrode 24, the oxygen electrode 24 is connected to the electrolyte 22.

The oxygen electrode 24 generates O₂ from O²⁻ transmitted thereto from the hydrogen electrode 21 via the electrolyte 22 by chemical reactions expressed by the following formula (5).

Oxygen electrode 24: 2O²⁻→O₂+4e⁻ . . . (5)

The oxygen electrode 24 is a porous body with oxide ionic conductivity and electronic conductivity. The oxygen electrode 24 can be made of, for instance, a composite material composed of an oxide ionic conductive material (GDC, etc.) and at least one selected from the group consisting of (La, Sr) (Co, Fe)O₃, (La, Sr)FeO₃, La(Ni, Fe)O₃, (La, Sr)COO₃, and (Sm, Sr)COO₃.

The oxygen electrode 24 is not particularly limited in porosity, and hence, can be set to have a porosity of, for instance, greater than or equal to 20% and less than or equal to 60%. The oxygen electrode 24 is not particularly limited in thickness, and hence, can be set to have a thickness of, for instance, greater than or equal to 1 μm and less than or equal to 100 μm.

The oxygen electrode 24 is not particularly limited in method of formation, and hence, can be formed by any of the methods such as firing, spray coating, PVD, and CVD.

### Channel Structure

The channel structure 3 is configured such that the raw material gas to be supplied to the cell body 2 and reducing gas (H₂ in the present preferred embodiment) generated in the hydrogen electrode 21 flow thereinto. When described in detail, the channel structure 3 includes the internal space 30. The raw material gas and the reducing gas flow into the internal space 30 of the channel structure 3. The channel structure 3 includes the support substrate 31 (exemplary first substrate), an inter-connector 32 (exemplary second substrate), and a plurality of spacers 33.

### Support Substrate

As shown in FIG. 2, the support substrate 31 supports the cell body 2. In the present preferred embodiment, the support substrate 31 is made in shape of a plate. Insomuch as the cell body 2 can be supported by the support substrate 31, the support substrate 31 is not particularly limited in thickness, and hence, can be set to have a thickness of, for instance, greater than or equal to 0.1 mm and less than or equal to 2.0 mm.

The support substrate 31 includes the first principal surface 311, a second principal surface 312, and the plural through holes 313 (exemplary gas permeated portion). In the present preferred embodiment, the first principal surface 311 is the upper surface of the support substrate 31, whereas the second principal surface 312 is the lower surface of the support substrate 31. The first principal surface 311 faces the cell body 2. The second principal surface 312 faces the inter-connector 32.

Each of the through holes 313 is configured to cause gas to permeate therethrough. Each through hole 313 penetrates the support substrate 31 from the first principal surface 311 to the second principal surface 312. Each through hole 313 is opened on each of the first and second principal surfaces 311 and 312. Because of this, gas permeates through the support substrate 31 via the through holes 313.

Each through hole 313 is covered with the cell body 2. Specifically, the first principal surface 311-side opening of each through hole 313 is covered with the hydrogen electrode 21. The second principal surface 312-side opening of each through hole 313 is connected to the internal space 30.

The respective through holes 313 can be formed by machining processing (e.g., punching), laser processing, chemical processing (e.g., etching), or so forth.

In the present preferred embodiment, each through hole 313 is shaped straight along the Z-axis direction. However, each through hole 313 may slant with respect to the Z-axis direction; besides or alternatively, each through hole 313 may not be shaped straight. Besides or alternatively, the through holes 313 may continue to each other.

The support substrate 31 is made of an alloy containing Cr (Chromium). Fe—Cr-based alloy steel (stainless steel, etc.), Ni—Cr-based alloy steel, or so forth can be exemplified as the alloy herein described. The support substrate 31 is not particularly limited in content rate of Cr, and hence, can be set to contain Cr at a content rate of greater than or equal to 4 mass % and less than or equal to 30 mass %.

The support substrate 31 may contain Ti (Titanium) and Zr (Zirconium). The support substrate 31 is not particularly limited in content rate of Ti, and hence, can be set to contain Ti at a content rate of greater than or equal to 0.01 mol % and less than or equal to 1.0 mol %. The support substrate 31 is not particularly limited in content rate of Zr, and hence, can be set to contain Zr at a content rate of greater than or equal to 0.01 mol % and less than or equal to 0.4 mol %. The support substrate 31 may contain Ti in the form of TiO₂ (titania) and may contain Zr in the form of ZrO₂ (zirconia).

### Inter-Connector

The inter-connector 32 is disposed on the same side as the second principal surface 312 of the support substrate 31. The inter-connector 32 is a member for electrically connecting the electrolytic cell 100 to either an external power source or another electrolytic cell.

The inter-connector 32 is made in shape of a plate. The inter-connector 32 is fixed at the outer peripheral part thereof to the support substrate 31. The inter-connector 32 is fixed to the support substrate 31 by, for instance, welding or bonding.

The inter-connector 32 is not particularly limited in thickness, and hence, can be set to have a thickness of, for instance, greater than or equal to 0.1 mm and less than or equal to 2.0 mm. The outer peripheral part of the inter-connector 32 protrudes toward the support substrate 31. The outer peripheral part of the inter-connector 32 defines the outer circumference of the internal space 30. It should be noted that the outer peripheral part of the inter-connector 32 may be provided as a member separated from the inter-connector 32. The inter-connector 32 includes a plurality of first protrusions 321 (exemplary protrusion) and a plurality of second protrusions 322.

Each of the first protrusions 321 protrudes toward the support substrate 31. Each first protrusion 321 is disposed inside the internal space 30. Each first protrusion 321 is not particularly limited in height, and hence, can be set to have a height of, for instance, greater than or equal to 0.1 mm and less than or equal to 2.0 mm.

Each of the second protrusions 322 protrudes to the opposite side to each first protrusion 321. Each second protrusion 322 is not particularly limited in height, and hence, can be set to have a height of, for instance, greater than or equal to 0.1 mm and less than or equal to 2.0 mm.

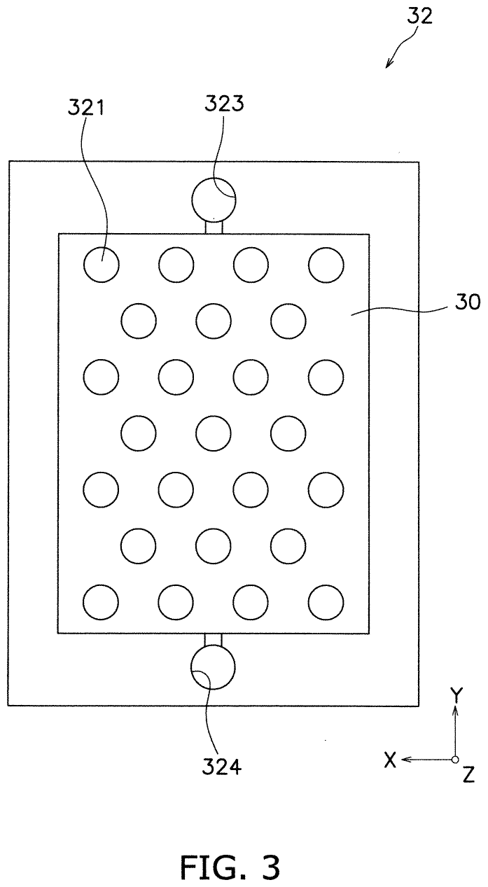

FIG. 3 is a plan view of the inter-connector 32. It should be noted that for easy understanding of the drawing, FIG. 3 illustrates only the first protrusions 321 without illustrating recesses to be actually observed as the back surfaces of the second protrusions 322. As shown in FIG. 3, the first protrusions 321 are disposed away from each other at intervals. Specifically, the first protrusions 321 are aligned in a staggered shape. The respective first protrusions 321 can be formed by processing the inter-connector 32 by stamping, cutting, etching, or so forth. It should be noted that the respective second protrusions 322 are configured in comparable manner to the respective first protrusions 321.

Each first protrusion 321 is larger than each through hole 313 in a plan view. Because of this, in the plan view, two or more of the plural through holes 313 overlap with each first protrusion 321.

The inter-connector 32 includes a supply hole 323 and a discharge hole 324. The supply hole 323 and the discharge hole 324 are communicated with the internal space 30. The supply hole 323 penetrates the inter-connector 32 in the Z-axis direction. The raw material gas, supplied to the electrolytic cell 100 from an external gas supply source, flows through the supply hole 323 in the Z-axis direction. The raw material gas is supplied to the interior of the internal space 30 via the supply hole 323.

The discharge hole 324 penetrates the inter-connector 32 in the Z-axis direction. H₂, which is generated in the hydrogen electrode 21 and flows through the internal space 30, is discharged to the outside via the discharge hole 324 and is recovered on the outside.

The inter-connector 32 is made of an alloy containing Cr. Fe—Cr-based alloy steel, Ni—Cr-based alloy steel, or so forth can be exemplified as the alloy herein described. The inter-connector 32 is not particularly limited in content rate of Cr, and hence, can be set to contain Cr at a content rate of greater than or equal to 4 mass % and less than or equal to 30 mass %. The inter-connector 32 may be identical in composition to or different in composition from the support substrate 31.

### Spacers

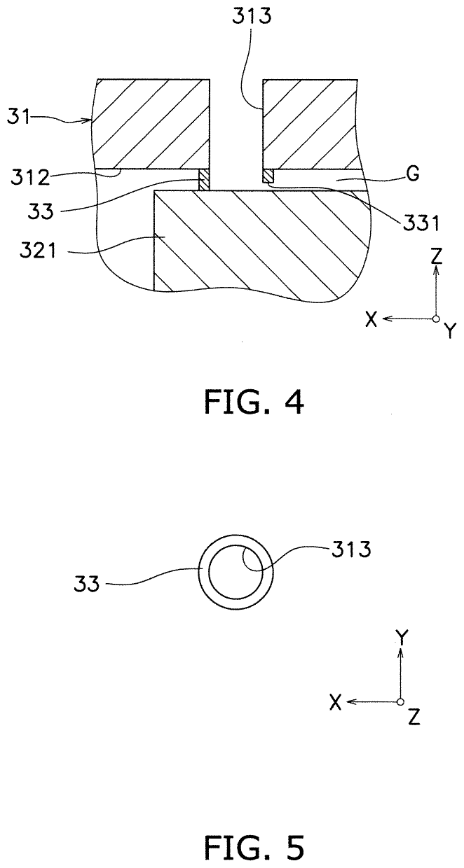

FIG. 4 is an enlarged cross-sectional view of the electrolytic cell 100, whereas FIG. 5 is a plan view of the support substrate 31 seen from the second principal surface 312 side. As shown in FIGS. 4 and 5, each spacer 33 is disposed between a relevant one of the first protrusions 321 and the support substrate 31. Each spacer 33 produces a gap G between the relevant first protrusion 321 and the support substrate 31. The gap G, produced by each spacer 33 between the relevant protrusion 321 and the support substrate 31, is not particularly limited in dimension, and hence, can be set to have a dimension of, for instance, greater than or equal to 1 μm and less than or equal to 300 μm.

Each spacer 33 is disposed along each through hole 313. When described in detail, each spacer 33 is disposed along the second principal surface 312-side opening edge of each through hole 313. Each spacer 33 extends in an annular shape. Each spacer 33 has a circular shape as seen in the Z-axis direction.

Each spacer 33 is fixed to the second principal surface 312 of the support substrate 31. When described in detail, each spacer 33 is provided on the support substrate 31. In other words, any gap is not produced between each spacer 33 and the support substrate 31.

Each spacer 33 is uneven in height. For example, each spacer 33 is different in height along the circumferential direction thereof. Each spacer 33 includes a part lower in height than the remaining part thereof. It should be noted that the term “height” of each spacer 33 refers to the dimension thereof in the Z-axis direction. Each spacer 33 is not in contact at the low-height part thereof with the relevant first protrusion 321. A space, produced at the low-height part of each spacer 33 not in contact with the relevant protrusion 321, causes each through hole 313 and the gap G to be communicated therethrough with each other. In other words, each spacer 33 includes a communicating means 331 that causes each through hole 313 and the gap G to be communicated therethrough with each other. The communicating means 331 is obtained, while each spacer 33 is not in contact, in part, with the relevant first protrusion 321.

Each spacer 33 is in contact, in part, with the relevant first protrusion 321. Each spacer 33 may or may not be fixed to the relevant first protrusion 321 at the part in contact therewith.

Each spacer 33 is made of a material higher in Young's modulus than the support substrate 31. Each spacer 33 is made of a material containing oxide. When described in detail, each spacer 33 is made of a material composed of only oxide. For example, each spacer 33 is made of oxide ceramics. More specifically, each spacer 33 can be made of Cr₂O₃, (Mn, Cr)₃O₄, (Mn, Cr, Fe)₃O₄, (Cr, Fe)₂O₃, Fe₂O₃, Fe₃O₄, Al₂O₃, ZrO₂, CeO₂, or so forth.

Each spacer 33 may be made of a metal containing material. The material of each spacer 33 may contain oxide as well as metal. For example, Fe, Co, Ni, Cu, or so forth can be exemplified as the metal contained in the material of each spacer 33. On the other hand, Cr₂O₃, (Mn, Cr)₃O₄, (Mn, Cr, Fe)₃O₄, (Cr, Fe)₂O₃, Fe₃O₄, Al₂O₃, ZrO₂, CeO₂, or so forth can be exemplified as the oxide contained in the material of each spacer 33.

All of the plural spacers 33 may be made of the material containing oxide; alternatively, all of the plural spacers 33 may be made of the material containing metal. Yet alternatively, at least one spacer 33 made of the material containing oxide and at least one spacer 33 made of the material containing metal may coexist as the plural spacers 33.

Each spacer 33 can be formed by applying a paste containing the material described above onto the second principal surface 312 of the support substrate 31 along the opening edge of each through hole 313 by a precision nozzle-equipped dispenser and then by firing the paste.

### Modifications

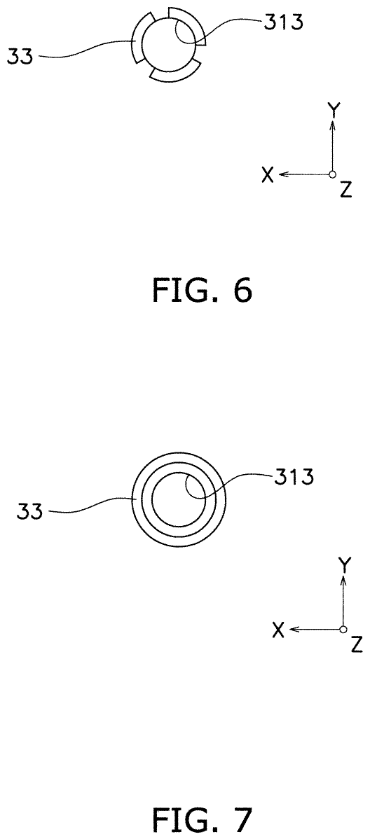

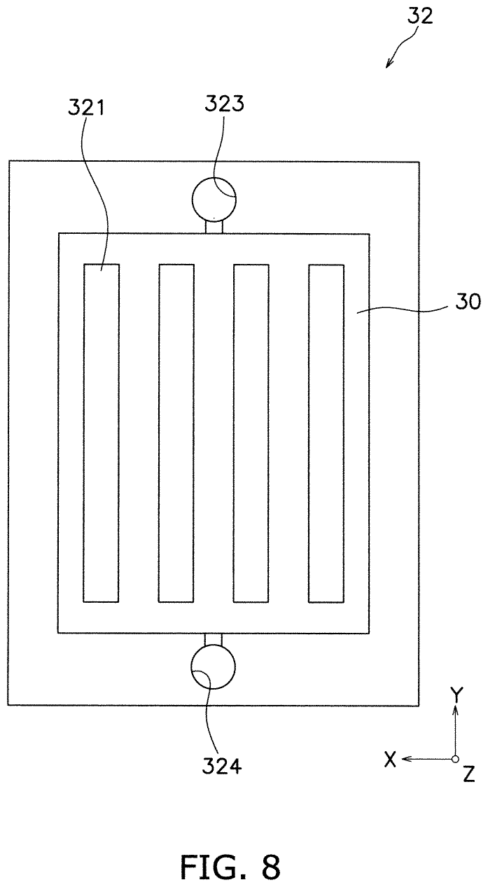

One preferred embodiment of the present invention has been explained above. However, the present invention is not limited to this, and a variety of changes can be made without departing from the gist of the present invention.
(a) In the preferred embodiment described above, each spacer 33 extends in an annular shape; however, each spacer 33 is not limited in shape to this. For example, each spacer 33 may be made in shape of a block or in any other shape insofar as being disposed between the relevant first protrusion 321 and the support substrate 31.
(b) Each spacer 33 may be even in height. In other words, each spacer 33 may be entirely in contact with the relevant first protrusion 321 in the circumferential direction thereof. In this case, each spacer 33 may be made of a material that enables gas to permeate therethrough, or alternatively, may be provided with at least one through hole that causes gas to flow therethrough in order to obtain the communicating means.
(c) In the preferred embodiment described above, each spacer 33 continuously extends in an annular shape; however, each spacer 33 is not limited in shape to this. For example, as shown in FIG. 6, each spacer 33 may intermittently extend in an annular shape. In this case, missing parts in the annular shape of each spacer 33 are served as the communicating means.
(d) In the preferred embodiment described above, each spacer 33 is disposed in contact with the opening edge of each through hole 313; however, each spacer 33 is not limited in positional arrangement to this. As shown in FIG. 7, each spacer 33 may be disposed away from the opening edge of each through hole 313 at an interval.
(e) In the preferred embodiment described above, each first protrusion 321 has a circular shape in the plan view; however, each first protrusion 321 is not limited in shape to this. For example, as shown in FIG. 8, each first protrusion 321 may have a rectangular shape in the plan view. Each first protrusion 321 may be elongated in either the Y-axis direction or the X-axis direction.
(f) In the preferred embodiment described above, each spacer 33 is provided as a member separated from the support substrate 31; however, each spacer 33 is not limited in configuration to this. For example, each spacer 33 may be provided as a single member integrated with the support substrate 31, or alternatively, may be provided as a single member integrated with the relevant first protrusion 321.
(g) In the preferred embodiment described above, the electrochemical cell is exemplified by the electrolytic cell but is not limited thereto. The electrochemical cell is a generic term for referring to a device for changing electric energy into chemical energy, in which a pair of electrodes is disposed to generate an electromotive force from entire oxidoreduction reactions, and a device for changing chemical energy into electric energy. Therefore, for instance, a fuel battery, in which oxide ions or protons act as carriers, is also considered as the electrochemical cell.

### REFERENCE SIGNS LIST

2: Cell body
3: Channel structure
31: Support substrate
313: Through hole
32: Inter-connector
321: First protrusion
33: Spacer
100: Electrolytic cell

1. A channel structure comprising:
a first substrate including a gas permeated portion causing a gas to permeate therethrough;
a second substrate including a protrusion protruding toward the first substrate; and
a spacer disposed between the protrusion and the first substrate, the spacer configured to produce a gap between the protrusion and the first substrate.

2. The channel structure according to claim 1, wherein the first substrate includes a through hole as the gas permeated portion.

3. The channel structure according to claim 2, wherein the spacer is disposed along the through hole.

4. The channel structure according to claim 3, wherein the spacer extends in an annular shape, the space uneven in height.

5. The channel structure according to claim 3, wherein the spacer intermittently extends in an annular shape.

6. The channel structure according to claim 1, wherein the spacer is fixed to the first substrate.

7. The channel structure according to claim 6, wherein the spacer is fixed to the protrusion.

8. The channel structure according to claim 1, wherein the spacer is made of a material containing oxide.

9. The channel structure according to claim 1, wherein the spacer is made of a material containing metal.

10. An electrochemical cell comprising:
the channel structure recited in claim 1; and
a cell body disposed on the first substrate.
